(19) United States
(12) Patent Application Publication
(10) Pub. No.: US 2021/0322892 A1
(43) Pub. Date: Oct. 21, 2021

(54) PURIFIED ETHANOL FROM FUEL ETHANOL PROCESS

(71) Applicant: POET Research, Inc., Sioux Falls, SD (US)

(72) Inventors: David Charles Carlson, Brandon, SD (US); Casey Ryan Baumiller, Parkston, SD (US); Brady Christopher Clavel, Yankton, SD (US); Adam M. Hass, Brandon, SD (US); Tyler Glenn Leonard, Sioux Falls, SD (US); James R. Schock, Sioux Falls, SD (US)

(21) Appl. No.: 17/320,848

(22) Filed: May 14, 2021

Related U.S. Application Data
(60) Provisional application No. 63/025,489, filed on May 15, 2020.

(51) Int. Cl. B01D 3/00; B01D 3/14; B01D 3/42; C12G 3/021; C12C 11/11

(52) U.S. Cl. CPC B01D 3/005; B01D 3/148; C12C 11/11; C12G 3/021; B01D 3/4283

(57) ABSTRACT

The present disclosure provides systems and methods for purifying ethanol.

### RELATED APPLICATIONS

The present nonprovisional patent application claims the benefit of commonly owned provisional application having Ser. No. 63/025,489, filed on May 15, 2020, wherein the entirety of said provisional application is incorporated herein by reference.

### BACKGROUND

Currently the United States has the capacity to produce approximately 16 billion gallons of ethanol for liquid transportation fuel using corn as the most common feedstock. The majority of this production is from dry mill ethanol facilities that predominately produce ethanol and distillers dried grains with solubles (DDGS). A general overview of the dry mill ethanol production process is shown in FIG. 1. In this process, the corn is first ground into a flour with one or more hammermills. The flour is then mixed with various sources of water and enzymes in the slurry or liquefaction step. In some processes, such as the BPX process utilized by POET, the corn slurry is mixed at relatively low temperatures, approximately 90 F to 100 F, and sent directly to the fermentation step without any additional processing. This process is commonly referred to as raw starch hydrolysis. In other processes, such as the traditional liquefaction process, the corn slurry is mixed at elevated temperatures, approximately 150 F-200 F, and then maintained at that temperature for an extended period of time to allow the enzymes to reduce the viscosity (or liquefy) the corn slurry. Some processes may also employ a short time, high temperature cooking process up to approximately 250 F to improve the liquefaction of the corn slurry. It may be necessary to add enzymes before and after the high temperature cooking process due to enzyme denaturation that may occur.

The corn slurry, or liquefied corn slurry, is then typically fermented with Saccharomyces cerevisiae yeast in a simultaneous saccharification and fermentation (or SSF) mode. In this mode, enzymes added to the slurry convert the corn starch into soluble glucose at the same time as the yeast converts the soluble glucose into ethanol and carbon dioxide. After the fermentation is complete, the resulting fermentation broth, or beer, is distilled in order to separate the ethanol from the water and remaining solids. A diagram showing the typical dry mill ethanol distillation process is shown in FIG. 2. The typical distillation process uses three individual distillation columns, a beer stripper, rectifier, and side stripper. The beer is first fed into the top of the beer stripper, which removes the more volatile ethanol into the overhead vapor stream. Energy for the beer stripper may be supplied from a reboiler, direct-inject steam from a utility boiler, or as waste heat vapor from a downstream evaporation process. The liquid leaving the bottom of the beer stripper contains all the residual corn solids and is referred to as whole stillage. The overhead vapor from the beer stripper is sent into the bottom of the rectifier column, which concentrates the ethanol to near the azeotropic concentration of approximately 95%. The bottoms stream from the rectifier contains both water and ethanol and is sent to the top of the side stripper. The side stripper uses energy from either a reboiler, direct-inject steam, or process steam from an evaporation system to remove the ethanol from the water. The overhead vapor from the side stripper is combined with the overhead vapor from the beer stripper and sent to the rectifier and the side stripper bottoms stream is typically used as part of the water required to mix with the corn flour at the beginning of the process. A molecular sieve dehydration system is then typically used to remove the remaining water from the ethanol in order to produce ASTM fuel grade ethanol.

The whole stillage from the distillation system is processed in one or more decanters in order to separate the suspended solids from the remaining liquid and dissolved solids. The separated suspended solids, or wet cake, is sometimes sold as an animal feed as-is (distillers wet grains), but most often is dried down to approximately 10% moisture and sold as distillers dried grains with solubles (DDGS). The liquid stream from the decanters that consists primarily of water and dissolved solids is referred to as thin stillage, and a portion of this stream is used as makeup water in the slurry step at the beginning of the process. The remainder of the thin stillage is concentrated in an evaporator to form syrup that is combined with the wet cake in the drier. The water removed from the thin stillage by evaporation, commonly referred to as distillate, is also reused as makeup water in the slurry step at the beginning of the process. The vapor stream from the dryer contains volatile organic compounds in addition to the evaporated water, and a thermal oxidizer is typically used to destroy these compounds before the clean water vapor is exhausted to the atmosphere.

In addition to ethanol and carbon dioxide as the major products of the fermentation process, there are also a number of other organic compounds produced in relatively minor amounts. A number of these compounds, commonly referred to as congeners, have a similar volatility as ethanol and are typically present in the fuel grade ethanol. Some of these compounds include acetaldehyde, methanol, isopropanol, 1-propanol, ethyl acetate, 2-butanol, isobutanol, amyl alcohol, isoamyl alcohol, and others. The higher alcohol compounds such as isopropanol, 1-propanol, 2-butanol, isobutanl, amyl alcohol, isoamyl alcohol, and others are commonly referred to as fusel oils. There are no defined specifications for the limits of most of these congeners that may be present in ASTM fuel grade ethanol, as the ethanol is intended for use in internal combustion engines where these compounds have no effect. The only relevant ASTM specifications that may apply to these congeners are a limit on the amount of methanol (0.5% v/v max) due to political and commercial reasons, a limit to the acidity (0.007 mg/L acetic acid max), and a limit on the gum content (5.0 mg/100 mL max). In addition to being sold as fuel, ethanol may also be used as an ingredient in other industrial products or processes, or may be purified for human consumption. In either of these cases, it is necessary to further purify the ethanol and reduce the concentrations of many of the congeners. Depending on the intended market for the ethanol it may be necessary to meet one or more of the specifications published by the United States Pharmacopeia (USP), the Food Chemicals Codex (FCC), or the American Chemical Society (ACS). As an example, the USP specification for ethanol requires the concentrations of methanol to be less than 200 μL/L, the sum of acetaldehyde and acetaldehyde diethyl acetal (also known as 1,1-diethoxyethane and often referred to simply as acetal) to be less than 10 μL/L, benzene to be less than 2 μL/L, and the sum of all other impurities to be less than 300 μL/L. By comparison the typical concentrations in ASTM fuel grade ethanol may be 100 to 500 μL/L of methanol, 100 to 500 μL/L of acetaldehyde, and 1,000 to 10,000 μL/L of all other impurities. Benzene is typically not detected in ethanol produced from the fermentation of grain, but may be present in synthetic ethanol produced from petrochemical feedstocks.

ASTM fuel grade ethanol may be further purified to meet the USP specification by the use of additional distillation steps. These additional distillation steps may be ‘bolted on’ to an existing distillation system already producing ASTM fuel grade ethanol as shown in FIG. 3. In this configuration the 190 proof ethanol from the standard distillation process is further purified in three subsequent distillation steps. First, an extractive distillation step with water is used to remove fusel oils and other more volatile compounds from the ethanol. In this step, a significant amount of water is used to reduce the ethanol concentration throughout the entire column and increase the relative volatility of the contaminants being removed. The energy for this distillation step may be supplied in the form of direct-inject boiler steam or a reboiler may be used to evaporate a portion of the bottoms stream. The overhead product stream from this column contains the undesired fusel oils and other volatile compounds and may be recycled back into the ASTM fuel grade ethanol. The bottoms stream from the extractive distillation typically contains between 8%-15% ethanol and is sent to the second rectification step. In the rectification step, the ethanol is again concentrated to near the azeotropic concentration of approximately 95%. The energy for this distillation step may be supplied in the form of direct-inject boiler steam or a reboiler may be used to evaporate a portion of the bottoms stream. There are typically several side draws on the column to remove trace amounts of fusel oils that would otherwise accumulate in the column. The product ethanol is also typically removed as a side draw a few trays down from the top of the column. The overhead product from the column will contain higher amounts of acetaldehyde, methanol, and other more volatile impurities and this stream may be recycled back into the ASTM fuel grade product. The azeotropic 190 proof ethanol from the rectification column is then typically processed in a third and final demethylization column to remove methanol and other more volatile impurities. For this step, the 190 proof feed is injected into the middle of the column and the methanol and other impurities are removed from the top while the purified ethanol stream is collected in the bottoms stream. It is necessary to use a reboiler to provide the energy for this step in order to avoid adding any additional water into the final separation process. These three additional distillation steps are discussed in detail by Chambers, Murtagh, and Piggot (see “References” below). Alternatively, depending on the source of raw material used for ethanol production and the desired level of purity it may not be necessary to include a demethylization step in the purification process. This configuration is shown in FIG. 4.

### SUMMARY

Embodiments of the present disclosure include a method of integrating the production of high grade ethanol into a fuel grade ethanol facility including:
processing beer containing ethanol from a fermentation process in a first distillation system, including:
   feeding the ethanol to a first stripper, the ethanol containing a first quantity of impurities;
   feeding an overhead vapor stream from the first stripper to a first rectifier;
   feeding a bottom stream from the first rectifier to a second stripper;
   feeding steam to the bottom of the second stripper at a rate that leaves 5% to 100% of the ethanol entering the side stripper in the side stripper bottoms;
feeding the second stripper bottoms to a second distillation system; and
withdrawing ethanol from the second distillation system having a second quantity of impurities, the second quantity of impurities being less than the first quantity of impurities.

### BRIEF DESCRIPTION OF THE DRAWINGS

FIG. 1 is a process flow diagram illustrating a general overview of a dry mill ethanol production process;

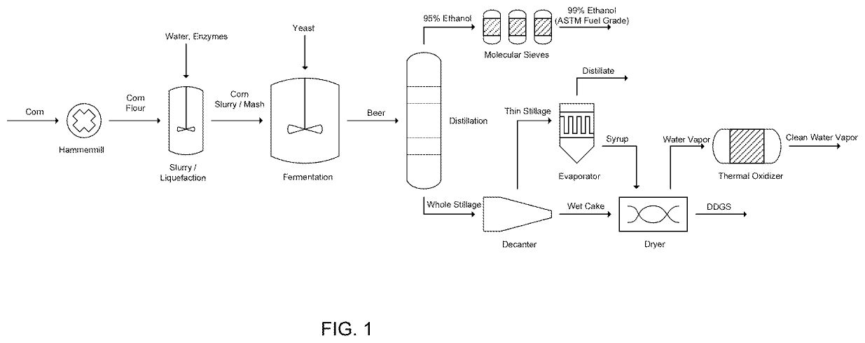

FIG. 2 is a process flow diagram illustrating a typical dry mill ethanol distillation process;

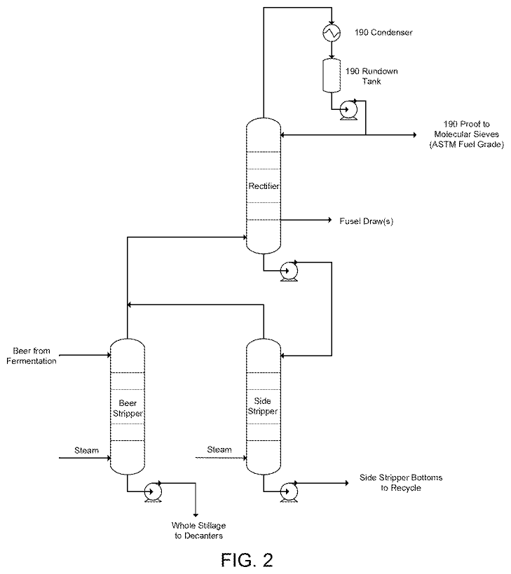

FIG. 3 is a process flow diagram illustrating a typical dry mill ethanol distillation process with traditional ethanol purification including methanol removal;

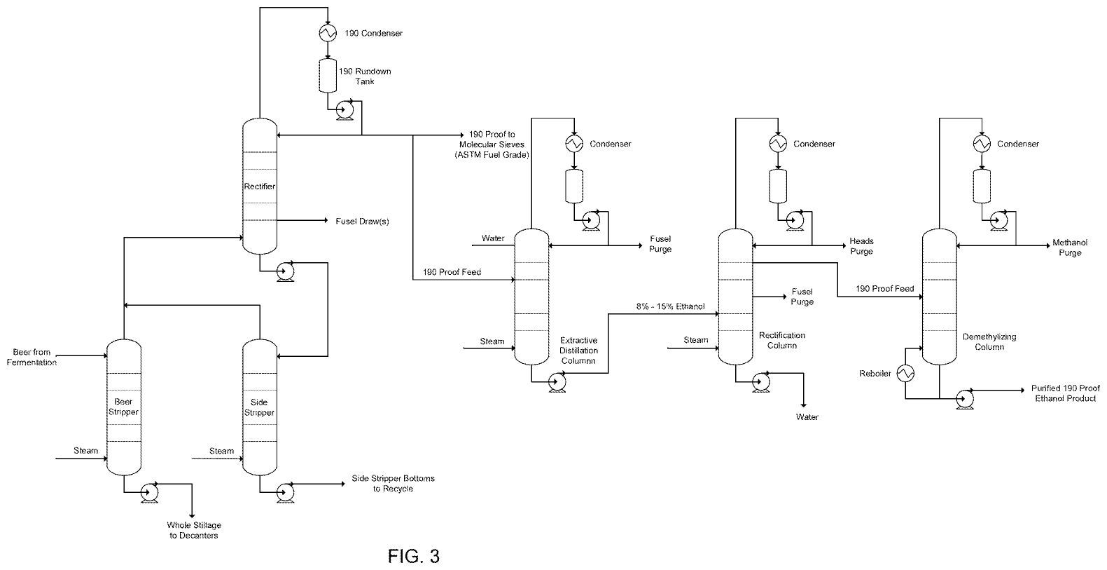

FIG. 4 is a process flow diagram illustrating a typical dry mill ethanol distillation process with traditional ethanol purification without methanol removal;

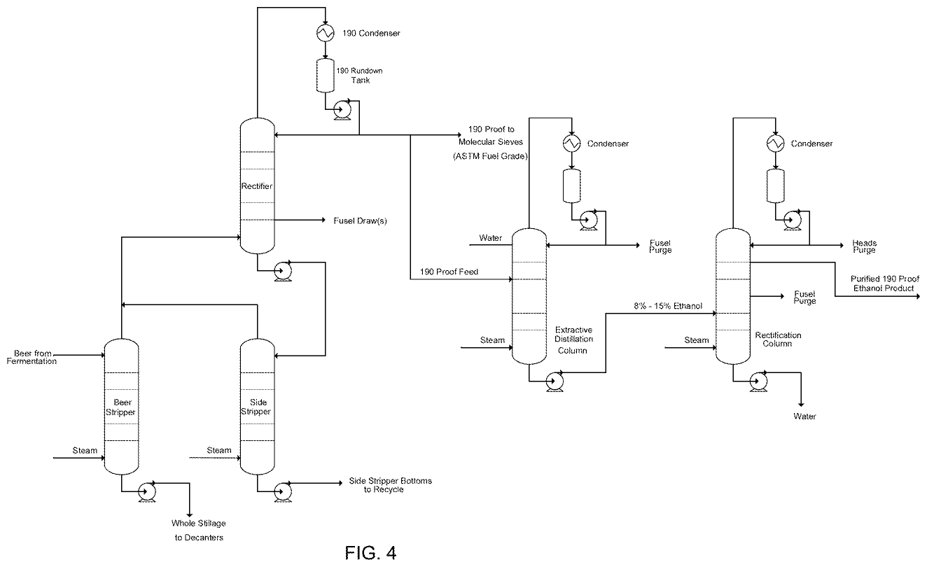

FIG. 5 is a process flow diagram illustrating an embodiment according to the present disclosure of a dry mill ethanol distillation process with integrated ethanol purification including methanol removal;

FIG. 6 is a process flow diagram illustrating another embodiment according to the present disclosure of a dry mill ethanol distillation process with integrated ethanol purification without methanol removal;

FIG. 7 is a process flow diagram illustrating another embodiment according to the present disclosure of a dry mill ethanol distillation process with integrated ethanol purification using repurposed equipment;

FIG. 8 is a process flow diagram illustrating another embodiment according to the present disclosure of a dry mill ethanol distillation process with simplified integrated ethanol purification using repurposed equipment; and

FIG. 9 is a process flow diagram illustrating another embodiment according to the present disclosure of a dry mill ethanol distillation process with simplified integrated ethanol purification using repurposed equipment without heads purge.

### DETAILED DESCRIPTION

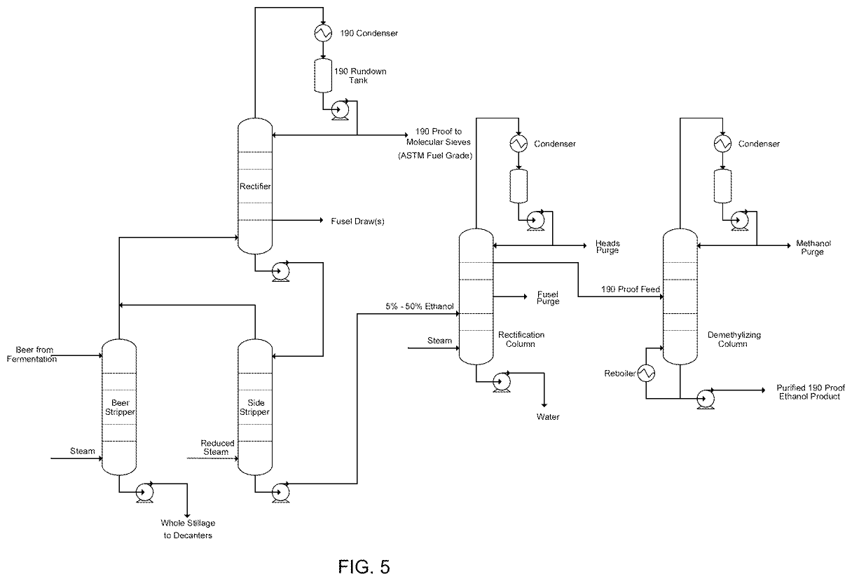

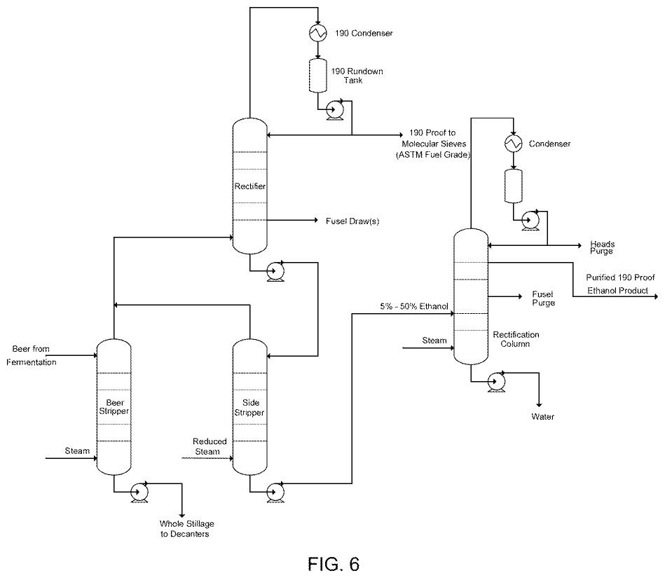

One novel method for integrating the production of USP grade ethanol into a dry mill facility already producing ASTM fuel grade ethanol is shown in FIG. 5. In this process, the side stripper from the traditional dry mill ethanol production process is operated to remove impurities by passing volatile impurities out the top of the side stripper while producing a significant amount of ethanol in the bottoms of the side stripper. This is counter to how a side stripper is normally operated. Normally, a side stripper is operated to minimize the amount of ethanol in the bottoms and is typically in the range of 1% or less of the ethanol entering the side stripper. In the present invention, the side stripper is operated to remove impurities while passing 5% to 100% of the ethanol entering the side stripper to the side stripper bottoms; in an embodiment greater than 10%; in an embodiment greater than 30%; in an embodiment greater than 50%; in an embodiment greater than 75%; in an embodiment greater than 90%. The resulting side stripper bottoms stream may contain 5% to 50%, even 8% to 40%, even 8% to 15% ethanol concentration. This is different from an extractive distillation step in a traditional ethanol purification process. The primary differences between these two methods is that the traditional extractive distillation column includes a zone of relatively constant ethanol concentration above the feed tray due to the introduction of water to the column at a location above the feed tray. By contrast, the column in the proposed system configuration and method has a decreasing ethanol concentration from the top to the bottom of the column. The ethanol concentration feeding the side stripper (rectifier column bottoms) and/or the steaming rate to the side stripper are adjusted in order to remove volatile contaminants while passing ethanol through the bottoms. At a minimum, the steam rate to the bottom of the side stripper is significantly reduced compared to its normal operation in order to leave a significant portion of ethanol in its bottoms stream that is then further purified. For example, acetaldehyde, methanol, sulfides and other volatile contaminants may be removed via the top stream of the side stripper. In the illustrative example of FIG. 5, the bottoms stream from the side stripper is processed through rectification and demethylization steps. A heads purge from the rectifier may be used to remove e.g. acetaldehyde, methanol, sulfides and other volatile contaminants. Alternatively, if the demethylization step is not required, there may only be the single rectification step in addition to the typical dry mill ethanol distillation process equipment as shown in FIG. 6.

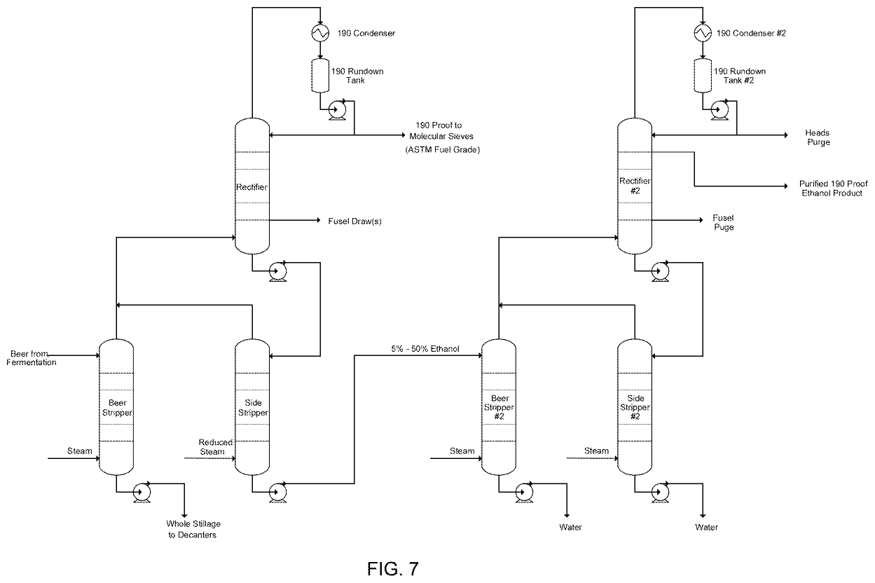

The novel ethanol purification method described above may be particularly suitable to implement at dry mill ethanol production facilities that have been expanded by adding an additional set (or train) of distillation columns. Rather than using the second distillation train to process additional beer it may be utilized to further refine the ethanol produced from the first train as shown in FIG. 7. In this configuration the bottoms of the side stripper from the first train is sent to the beer stripper of the second train. The beer stripper, rectifier, and side stripper from the second train operate similarly to how they would in a normal configuration to produce near azeotropic ethanol from the top of the rectifier and ethanol-free water from the bottoms of both of the stripper columns. The energy for both of the stripper columns may be supplied by either direct-inject boiler steam, process steam from an evaporator, or from a reboiler. A purge stream of fusel oils is removed from the rectifier and sent back to the first distillation train for reprocessing into fuel grade ethanol. The purified ethanol product is withdrawn from a tray near the top of the rectifier, and the overhead product, which may contain higher levels of volatile impurities such as acetaldehyde or methanol, is sent back to the first distillation train for reprocessing. Alternatively, if a sufficient quantity of volatile impurities have been removed in the side stripper from the first train, the overhead stream of the rectifier from the second train may be used as the purified ethanol product.

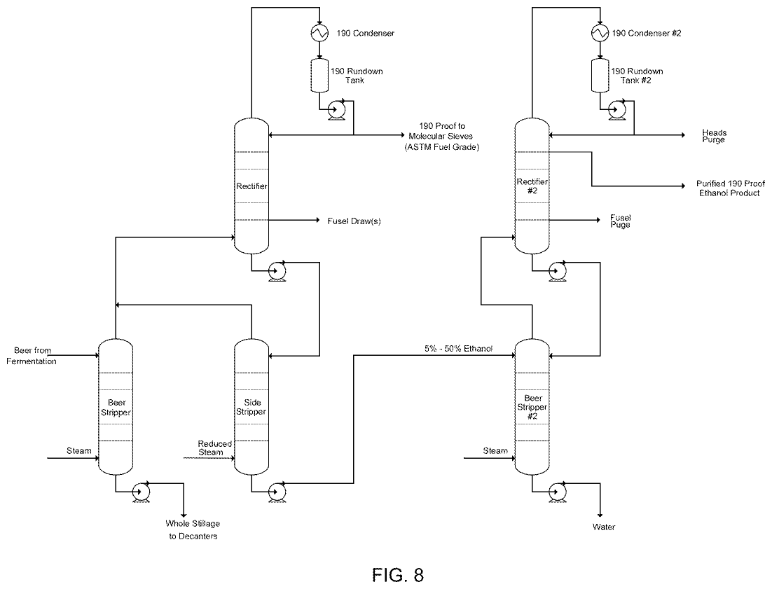

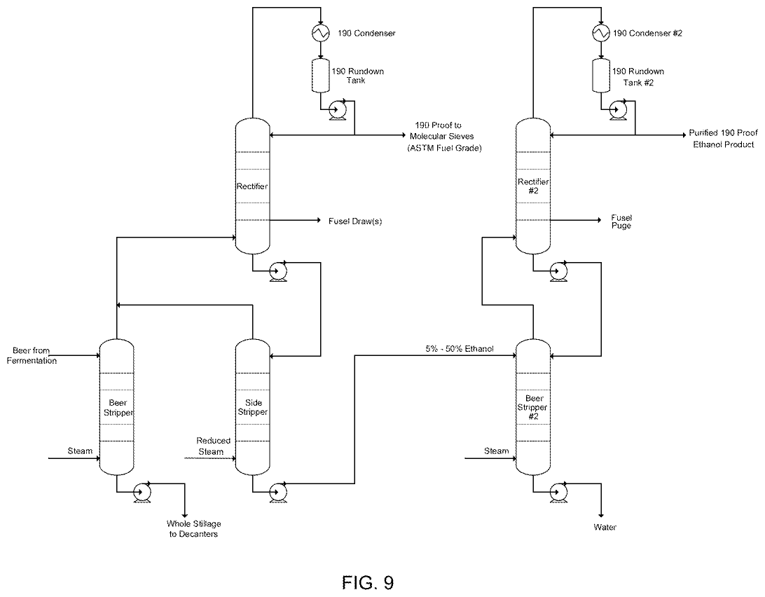

In addition to the novel ethanol purification method described above, the system may be further simplified by sending the bottoms of the train two rectifier back to the train two beer stripper rather than the side stripper as shown in FIG. 8. The normal reason to separate the rectifier bottoms into a separate column from the beer stripper is to minimize the amount of water in the whole stillage that will eventually be removed through either centrifugation or evaporation. In the ethanol purification mode, the present inventors recognized that neither of the bottoms streams from either the beer stripper or side stripper contain any solids, so there is no need to keep them separate. Also, depending on the degree of purification required and the quantity of volatile impurities removed in the side stripper from the first train, the overhead stream of the rectifier from the second train may be used as the purified ethanol product (as shown in FIG. 9) rather than removing it from a side draw.

### Example 1

A pilot scale distillation system was configured as shown in FIG. 9 and operated at steady state for 50 hours. Beer from a fermentation system at an average ethanol concentration of 18.8% v/v was fed to the beer stripper at an average flowrate 80.0 gallons per minute (gpm). Prior to and during the steady state run the 190 proof ethanol produced from the rectifier on average contained 555 μL/L of acetaldehyde+acetal, 128 μL/L of methanol, and 362 μL/L of total other impurities. During the steady state run the rectifier bottoms from the first train at an average ethanol concentration of 21.3% v/v was fed to the side stripper at an average flow of 16.6 gpm. The energy input into the side stripper was reduced such that the average ethanol concentration of the bottoms stream was 13.7% v/v. The side stripper bottoms stream, measured at 15.3 gpm, was continuously fed into the beer stripper of the second distillation train. The second distillation system was operated at a reflux ratio of 3.0 and with a sufficient amount of direct-inject boiler steam to ensure a negligible concentration of ethanol in the beer stripper bottoms stream. A fusel draw stream of on average 0.54 gpm was removed from different draw ports on the rectifier and returned to the first distillation train for reprocessing. Condensed overhead product from the second rectifier was removed as the purified 190 proof ethanol product with no additional heads purge stream. The average concentration of the purified ethanol was 4.9 μL/L acetaldehyde+acetal, 125 μL/L methanol, and 15.5 μL/L total other impurities.

### REFERENCES

ASTM D4806-12, Standard Specification for Denatured Fuel Ethanol for Blending with Gasolines for Use as Automotive Spark-Ignition Engine Fuel
The United States Pharmacopeial Convention, Alcohol
The Alcohol Textbook 3^{rd} Edition. Chapter 13—Production of neutral spirits and preparation of gin and vodka, J. E. Murtagh
The Alcohol Textbook 5^{th} Edition, W. M. Ingledew, D. R. Kelsall, G. D. Austin, and C. Kluhspies. Chapter 30—Beverage Alcohol Distillation, R. Piggot
U.S. Pat. No. 2,647,078. Alcohol distillation process, J. M. Chambers

What is claimed is:

1. A method of integrating the production of high grade ethanol into a fuel grade ethanol facility comprising:
processing beer containing ethanol from a fermentation process in a first distillation system, comprising:
feeding the ethanol to a first stripper, the ethanol containing a first quantity of impurities;
feeding an overhead vapor stream from the first stripper to a first rectifier;
feeding a bottom stream from the first rectifier to a second stripper;
feeding steam to the bottom of the second stripper at a rate that leaves 5% to 100% of the ethanol entering the side stripper in the side stripper bottoms;
feeding the second stripper bottoms to a second distillation system; and
withdrawing ethanol from the second distillation system having a second quantity of impurities, the second quantity of impurities being less than the first quantity of impurities.

2. The method of claim 1 wherein the first quantity of impurities comprises one or more impurities selected from the group consisting of acetaldehyde, methanol, isopropanol, 1-propanol, ethyl acetate, 2-butanol, isobutanol, amyl alcohol, and isoamyl alcohol.

3. The method of claim 1 wherein the second stripper has a decreasing ethanol concentration from the top to the bottom.

4. The method of claim 1 further controlling the ethanol concentration in the bottom stream from the rectifier feeding the second stripper in conjunction with the rate of steam fed to the second stripper to produce a desired amount of ethanol in the second stripper bottoms.

5. The method of claim 1 wherein the amount of ethanol in the second stripper bottoms is greater than 10% of the ethanol entering the second stripper.

6. The method of claim 1 wherein the amount of ethanol in the second stripper bottoms is greater than 30% of the ethanol entering the second stripper.

7. The method of claim 1 wherein the amount of ethanol in the second stripper bottoms is greater than 50% of the ethanol entering the second stripper.

8. The method of claim 1 wherein the amount of ethanol in the second stripper bottoms is greater than 75% of the ethanol entering the second stripper.

9. The method of claim 1 wherein the amount of ethanol in the second stripper bottoms is greater than 90% of the ethanol entering the second stripper.

10. The method of claim 1 wherein the second distillation system comprises a second rectifier including a column, the ethanol entering the second rectifier having a concentration from 5% to 50%, and the method further comprising withdrawing ethanol from the second rectifier column having a concentration of greater than 80%.

11. The method of claim 10 further comprising withdrawing the ethanol from the second rectifier column above a fusel purge port and below a heads purge port.

12. The method of claim 1 wherein the second distillation system comprises a third stripper and a second rectifier.

13. The method of claim 1 wherein the second distillation system comprises a third stripper, a second rectifier, and a fourth stripper.
